(19) United States
(12) Patent Application Publication
(10) Pub. No.: US 2019/0356074 A1
(43) Pub. Date: Nov. 21, 2019

(54) ELECTRICAL CORD CONNECTORS, ADAPTERS, ADAPTABLE REPLACEMENT CONNECTORS, NON WIRED MALE FITTINGS, AND A CHRISTMAS LIGHT SOCKET CLIP.

(71) Applicant: Cosimo Fuda, Toronto (CA)

(72) Inventor: Cosimo Fuda, Toronto (CA)

(21) Appl. No.: 16/423,145

(22) Filed: May 27, 2019

Related U.S. Application Data
(63) Continuation of application No. 15/629,733, filed on Jun. 21, 2017, now Pat. No. 10,404,004.
(60) Provisional application No. 62/352,886, filed on Jun. 21, 2016.

(51) Int. Cl. H01R 13/44; F21V 23/06; F21V 21/088; F21S 4/10; H01R 25/00; H01R 24/20; H01R 31/06; H01R 24/28; H01R 13/64

(52) U.S. Cl. CPC H01R 13/44; F21V 23/06; F21V 21/088; F21S 4/10; F21W 2121/00; H01R 24/20; H01R 31/06; H01R 24/28; H01R 13/64; H01R 25/003

(57) ABSTRACT

The present invention relates to electrical cords and more specifically to electrical cord connectors for various uses, including holiday lighting or for replacing a damaged connector end. The connectors used for holiday lighting allow Christmas light strings to be mounted or installed in either direction, or with either cord end at the intended power source. One electrical assembly can include a cord set having a male connector and a female connector at opposing ends, with the male connector having a receiving port, for receiving a corresponding female connector of another cord set, and a power adapter. The adapter includes both corresponding connectors of the cord set, and a male plug that plugs into an electrical outlet, to power the electrical assembly. A second electrical assembly or light string, includes a cord set having ‘just’ female connectors at opposing ends and a linking male fitting with prongs, an a corresponding adapter. One of the female connectors includes a receiving port for receiving a corresponding female connector of another cord set, and the prongs of the linking male fitting inserts into and through the first receptacle and then into the second female receptacle of the aligned female connectors, and electrically linking them together. A corresponding adapter powers the electrical assembly with ‘just’ female connectors. The light strings can further include a light socket clip that is spring operated. Replacement connectors can also be provided to replace various damaged male or female electrical connectors.

### FIELD

This present invention relates to electrical cords and more specifically to electric cord connectors.

### BACKGROUND

Electrical cords connect to power sources through male plugs into female electrical sockets, and electrical cords can be extended through a female connector of one cord connecting to a male connector of another cord. However, electrical cords are sometimes hung or installed in reverse, or the electrical cord connectors may get damaged and require replacing. For example, outdoor Christmas lights can accidently be installed in reverse, with the male plug furthest away from the intended power source, requiring either a long extension cord to connect the male plug end to the power source, or the lights to be taken down and reinstalled in the other direction with the connectors in the correct position. An unsafe option is to remove the female connector end, installing a male plug in its place, and then plugging into an outlet, creating a very dangerous electrical hazard at every male connection, and at the exposed prongs of the male plug at the opposite end of the lights.

The contents of all of these patents and published applications are hereby incorporated by reference. Various modifications and combinations have been envisaged for electrical plugs, receptacles, adapters and combinations therein, as set out in U.S. Pat. Nos. 5,232,381, 4,904,195 and 7,029,312 describes an electrical cord with a male plug at both ends, for use when an electrical cord or a string of lights ends in a female connector at the electrical outlet, instead of a male plug.

### SUMMARY

The first aspect of the present invention, provides for installing an electrical cord or a string of lights in either direction. The first version includes an electrical cord manufactured with a “male” connector end and a “female” connector end. The male connector includes a receiving port, sized to receive the corresponding female connector of another electrical cord or adapter, and provides part of the safety aspect to operate these electrical cord sets. A power adapter cord is used to connect these cords or light strings to a power source, which includes both corresponding connectors of the cord set, along with a male plug for connecting to the power source, and allowing the lights, including Christmas lights, to be installed or mounted in either direction. A splitter adapter cord can also be provided to connect and install multiple cords in different directions.

A second version also provides for installation of an electrical cord or a string of lights in either direction. The electrical cord having just “female” connectors, and a linking male fitting, for connectively linking the connectors. The electrical cord includes at least one connector with a receiving port, sized to receive the corresponding female connector of another string of lights or electrical cord. The female connector with receiving port includes an electrical receptacle with a hot contact slot and neutral contact slot that is continuous and open to the receiving port below, for aligning with the contact slots of the corresponding female connector. The linking male fitting includes a hot prong and a neutral prong, for inserting into both female connectors, and to complete the electrical connection of the two electrical cords. An adapter cord includes both female connectors of the cord or lights installed, for connecting to the corresponding end of the lights or connector, and also includes a male plug, to plug into an electrical outlet and power the lights.

These connectors mentioned above, can also be manufactured as replacement connectors to replace conventional male and female connectors, to save existing electrical cords or to replace a connector when it becomes damaged.

Another aspect of the present invention, provides for a light socket clip for an electrical cord, and for various holiday lighting, including Christmas lights. The light socket is one half of a spring operated clip, and can include either a compression spring or torsion spring. The compression spring can include a rubber boot cover to protect the spring from being damaged.

A further aspect of the present invention provides for a replacement male or female connector, or an adaptable connector, for repairing various electrical cords when the connectors become damaged. The female and male connectors can include common internal components, such as an inner housing and electrical contacts with wire terminals housed in the inner housing, for converting to or from either connector, by using a substitute mounting base and mounting cover. The electrical contacts are open from both ends, permitting a detachable mounting cover of the male connector to be inserted through the common internal parts and exit out the slot openings of the corresponding mounting base. A plug with a broken or missing ground prong, when a ground should be present, may still function, but is unsafe to use. The male cover can be easily replaced if any of the prongs become damaged, and without requiring any re-wiring of the connector.

The adaptable or replacement connector, either female or male, can save time and money, by not having to replace the connector or electrical cord completely. The concept can be applied to other applications, such as a 3-way splitter adapter.

Another object of this invention is to apply the concept of the female connector having contact slots that are continuous and open from both sides of the connector, for use with a male fitting, and applied to other applications or electrical connections, including for possible RV and generator hookups.

The concepts mentioned above, may be applied for use in other applications or electrical connections.

### BRIEF DESCRIPTION OF THE FIGURES

For better understanding, these and other aspects of the present invention will be apparent from the brief description of the drawings and the following detailed description in which:

FIG. 1a shows a perspective view of a first embodiment of a female connector and a first embodiment of a male connector on the respective ends of a string of Christmas lights.

FIG. 1b shows a bottom perspective view of the first female connector of FIG. 1a.

FIG. 1c shows a bottom perspective view of the first embodiment male connector of FIG. 1a.

FIG. 2a shows a perspective view of an embodiment of a second female connector and a third female connector on the respective ends of a string of Christmas lights.

FIG. 2b shows a bottom perspective view of the second embodiment female connector of FIG. 2a.

FIG. 2c shows a bottom perspective view of the third embodiment female connector of FIG. 2a.

FIG. 2d shows a side perspective view of a first linking male fitting for connectively linking the contact slots of the second female connector to the contact slots of the third female connector of another Christmas light cord.

FIG. 2e is bottom perspective view of the first linking male fitting of FIG. 2d.

FIG. 2f shows an end view of the first linking male fitting of FIGS. 2d and 2e.

FIG. 2g shows a perspective view of two Christmas light strings, and a first linking male fitting attached on one end of one string of lights.

FIG. 3 shows the embodiments of the first female connector and first male connector of FIG. 1a of multiple cords, aligned together.

FIG. 4a shows the second embodiment female connector of one cord connected to the third embodiment female connector of another cord.

FIG. 4b shows a side perspective view of the first linking male fitting of FIGS. 2d-2f.

FIG. 4c shows the first linking male inserted into the aligned contact slots of the second and third female connectors.

FIG. 5a shows a side perspective view of an alternative second linking male fitting with an additional component of a light socket connector cap.

FIG. 5b shows a cross-sectional view of the second linking male fitting of FIG. 5a.

FIG. 5c shows a bottom perspective view of a third linking male fitting with an additional component of a female connector cap.

FIG. 5d shows a cross-sectional view of the third linking male fitting of FIG. 5c.

FIG. 6a shows a perspective view of a first embodiment of a power adapter cord comprising the first female connector and the first male connector of FIG. 1a, each connected to an electrical cord through a splitter, that is further connected to a fourth embodiment female connector for use with a detachable first activating male fitting.

FIG. 6b shows a second embodiment of a power adapter cord comprising the second and third female connectors of FIG. 2a, each connected to a cord through a splitter, that is further connected to the fourth embodiment female connector of FIG. 6a and includes the first activating male fitting of FIG. 6c to power the adapter cord.

FIG. 6c shows a perspective view of the fourth female connector and the first activating male fitting of the present invention.

FIG. 6d shows a back perspective view of the fourth embodiment female connector of FIGS. 6a-6c.

FIG. 6e shows a front perspective view of the first activating male fitting of FIGS. 6a-6c.

FIG. 6f shows a perspective view of the first activating male fitting inserted into the fourth female connector.

FIG. 7a shows the first embodiment power adapter cord with activating male fitting strap, connected to the weatherproof cover and electrical receptacle, and the fitting plugged into the outdoor electrical receptacle of FIG. 7b.

FIG. 7b shows a perspective view of an outdoor electrical box with a receptacle, an outdoor weatherproof cover, and the first activating male fitting.

FIG. 8 shows a first embodiment of a splitter adapter of the present invention comprising the first female and first male connectors from FIG. 1a, connected to a splitter, that is connected to a further first female connector from FIG. 1a.

FIG. 9 shows a second embodiment splitter adapter comprising the second female connector and the third female connector from FIG. 2a, connected to a splitter, that is connected to a further third female connector of FIG. 2a.

FIG. 10a shows an exploded view of a first embodiment light socket clip.

10b shows a side perspective view of the light socket clip of FIG. 11a.

FIG. 11a shows an exploded view of a second embodiment light socket clip.

FIG. 11b shows a side perspective view of the light socket clip of FIG. 11a.

FIG. 12a shows an exploded view of a first adaptable replacement male connector, including a removable male cover with prongs and a removable first mounting base.

FIG. 12b shows a perspective view of the adaptable male replacement connector of FIG. 12a with an electrical cord wired to it.

FIG. 13 shows a perspective view of a female receptacle cover and a second mounting base for use with the common internal components of the first adaptable replacement connector of FIG. 12a.

FIG. 14a shows a back side perspective view of an embodiment of a first connector adapter.

FIG. 14b shows a front side perspective view of the first embodiment connector adapter of FIG. 14a.

### DETAILED DESCRIPTION OF THE INVENTION

The present invention includes embodiments of various electrical female and male connectors. For simplicity and understanding of the present invention, various male connectors and male fittings may be referred to having “blades or prongs” and the reference to “blades or prongs” should be understood to have the same meaning for purposes of understanding the invention.

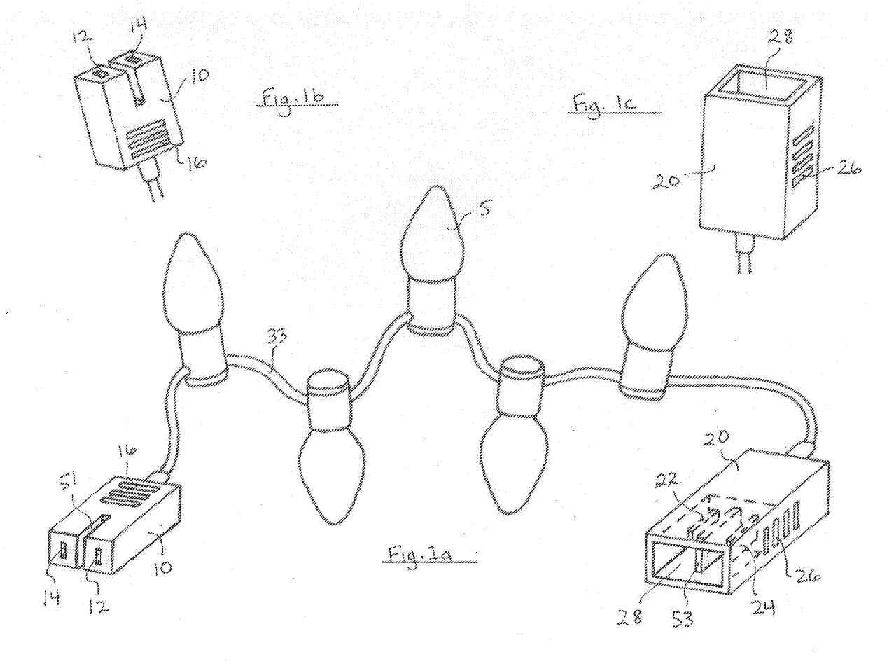

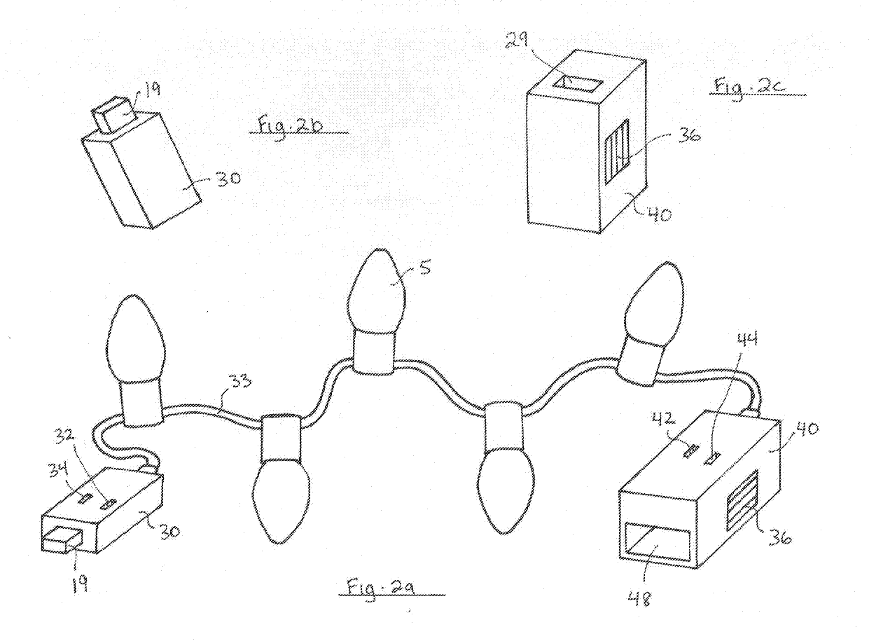

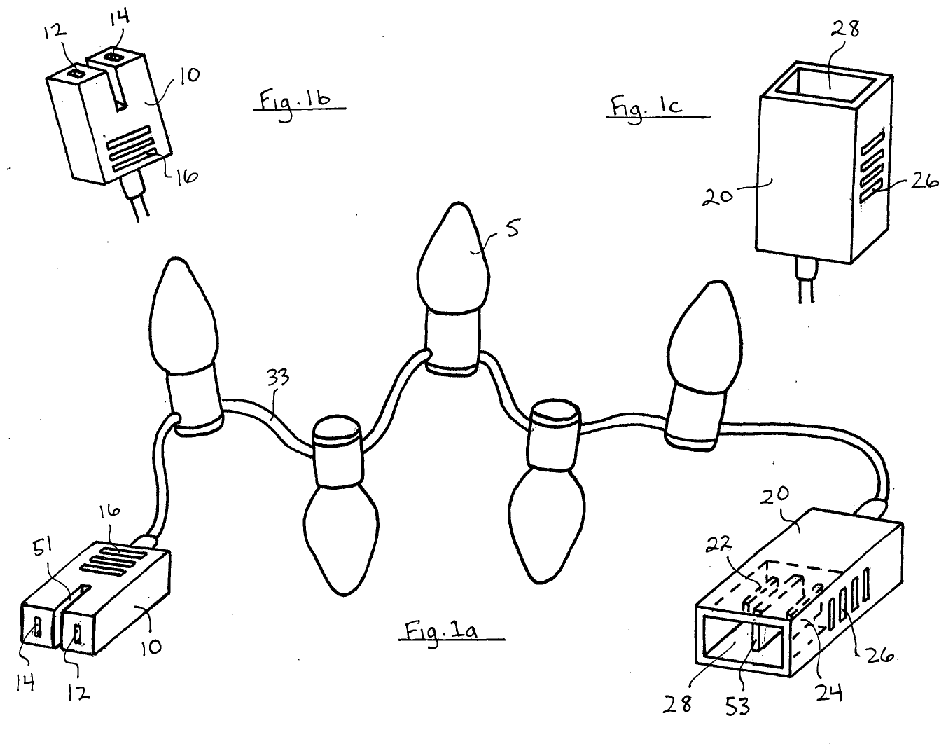

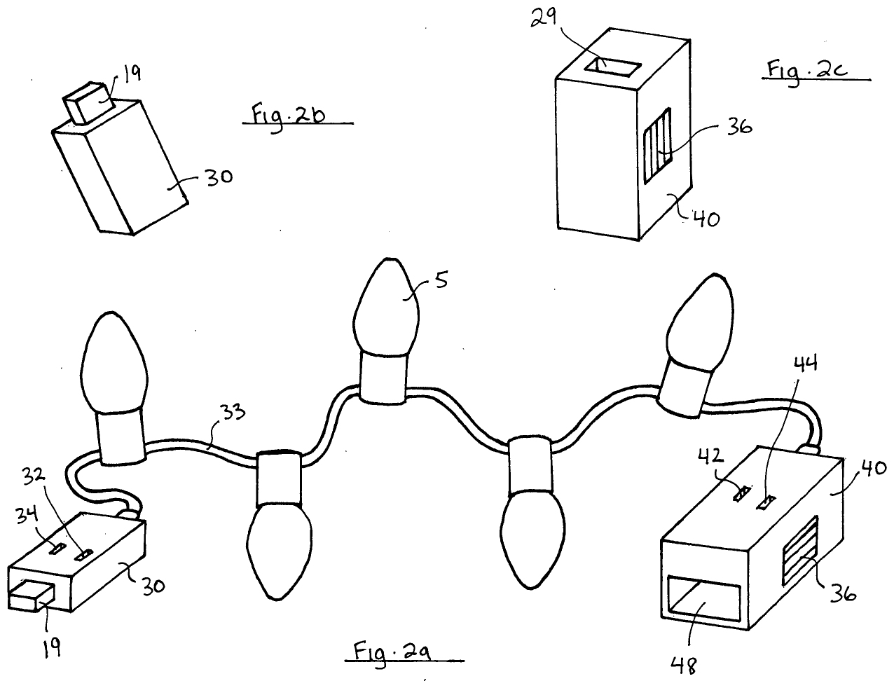

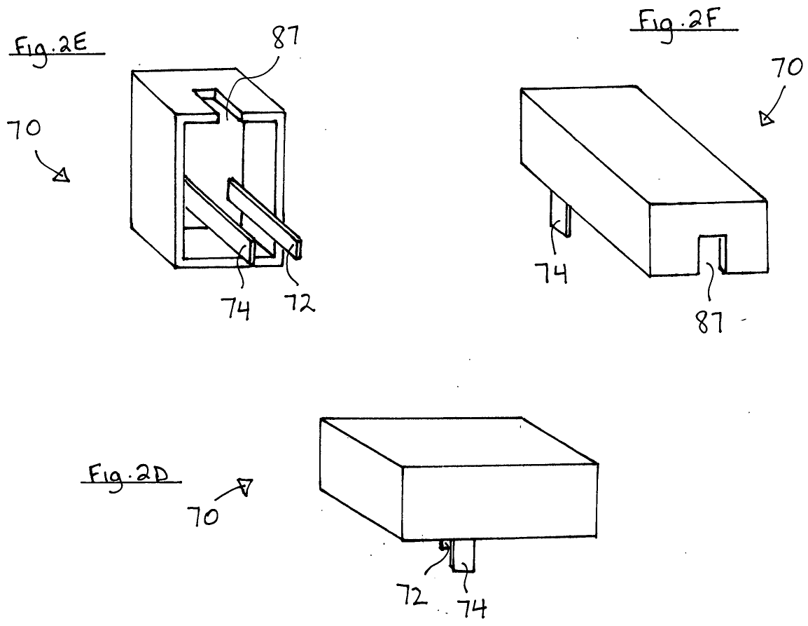

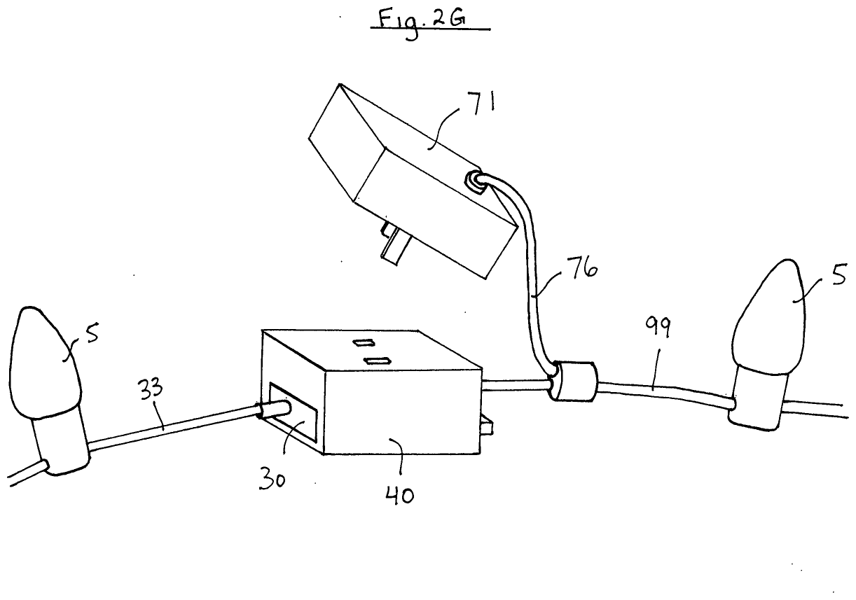

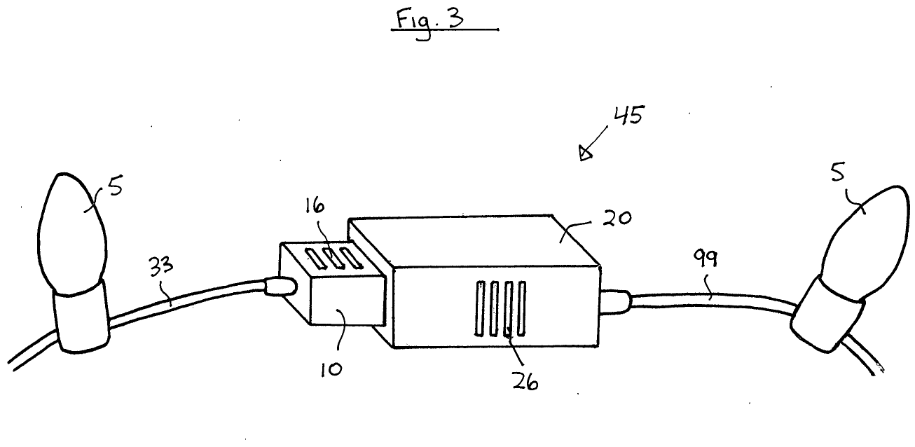

FIGS. 1 and 2 show two types of cord sets with various connectors that can be used for holiday lighting. Other figures below describe various adapters to provide power to these cords.

FIG. 1a shows a string of Christmas lights 5 having a first female connector 10 and a first male connector 20 at opposing ends of an electrical cord 33. The female connector 10 includes a molded outer housing enclosing an electrical receptacle, having a hot contact slot 12 and a neutral contact slot 14, on the end of the connector. A slot 51 is provided between the contact slots of the female connector 10, corresponding to a protective partition 53 of the male connector 20. The outer housing may optionally include grips 16 for gripping.

The first male connector 20, comprises a molded outer housing, with a hot prong (blade) 22, and a neutral prong (blade) 24, within a receiving port 28. The prongs of the connector are recessed further back from the entry of the receiving port 28 and the protective partition 53 separates the hot and neutral prong s, and acts as a safety feature to make physical contact with the prongs (blades) more difficult. The string of Christmas lights 5 on cord 33, can also have ends with multiple female connectors 10, or multiple male connectors 20, or a combination of a female and male connectors. Optionally the housing may include grips 26, for gripping and separating the two connectors.

FIG. 1b shows the bottom of the first female connector 10 with a hot slot 12 and a neutral slot 14, and first grips 16.

FIG. 1c shows a bottom perspective view of the first male connector 20 with receiving port 28 and second grips 26.

For simplicity, like components are given the same reference numerals.

FIG. 2a shows a string of Christmas lights 5 with an embodiment of a second female connector 30 and an embodiment of a third female connector 40, connected at opposing ends of an electrical cord 33. The female connector 30 includes an outer housing with an electrical receptacle on the top of the connector, having a hot contact slot 32 and a neutral contact slot 34. A tab 19 is provided on the free end of the female connector 30, for use with slot opening 29 in the back of the female connector 40, shown in FIG. 2c.

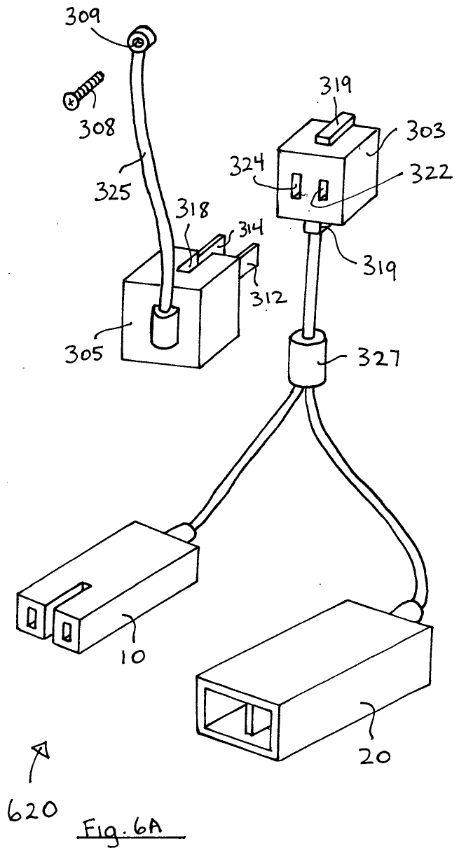

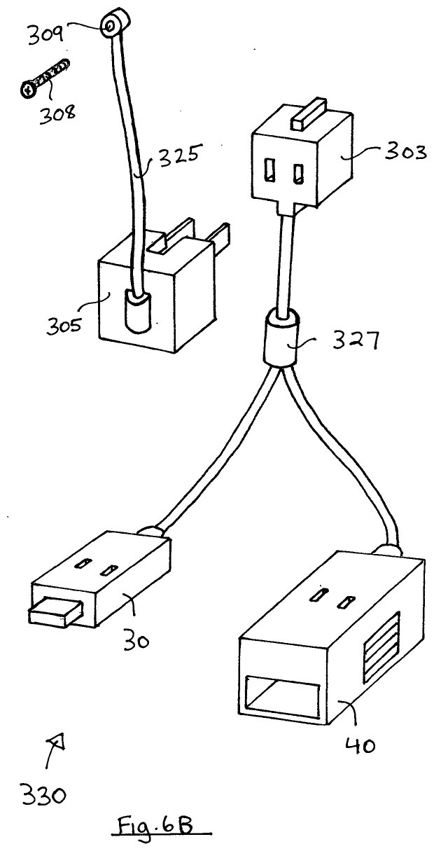

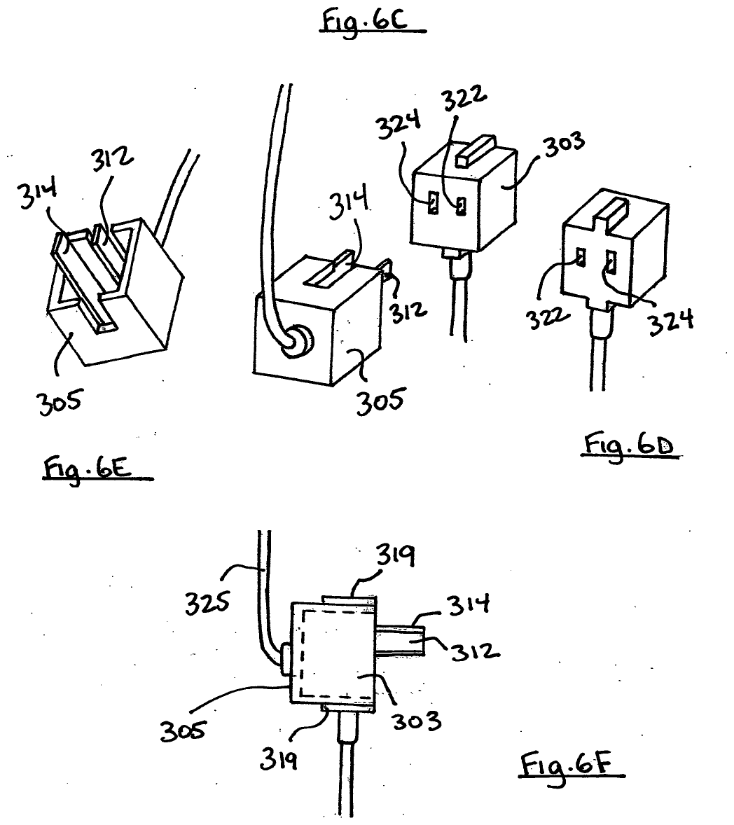

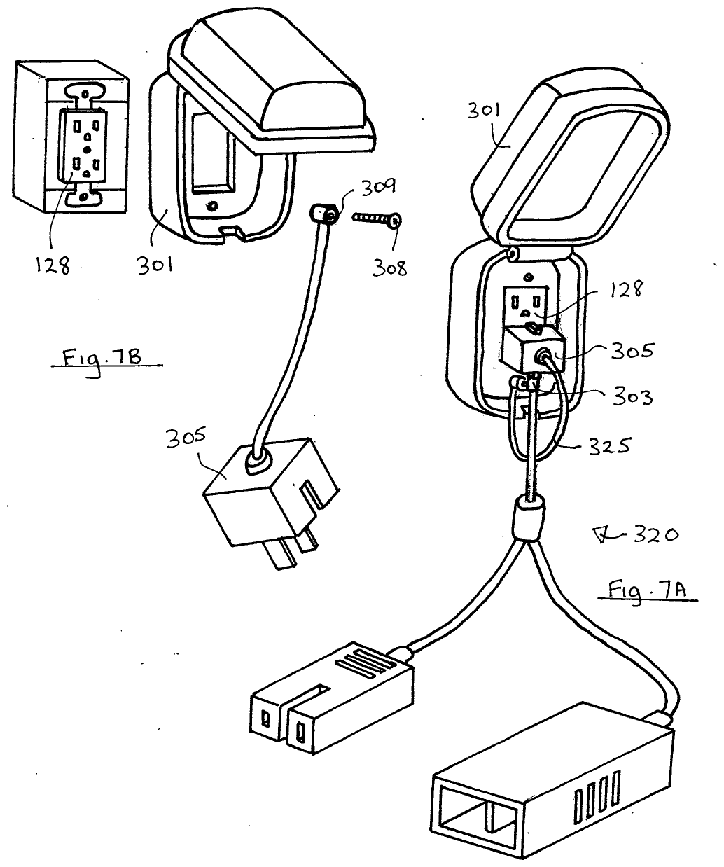

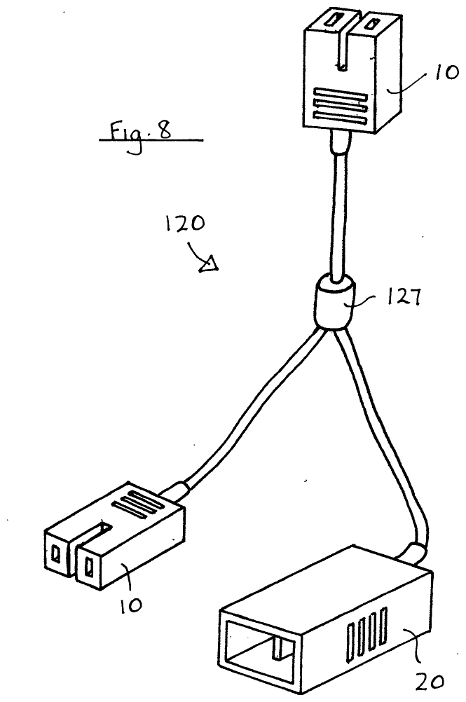

The third female connector 40, includes an outer housing with an electrical receptacle having a hot contact slot 42 and a neutral contact slot 44, that are continuous and opened to the receiving port 48, below. The receiving port 48 is partly closed on the other end, and includes a slot opening 29, as shown in FIG. 2c, allowing tab 19, on the end of connector 30, to exit past the opening. The partly closed end acts as a stop when receiving the second female connector 30, aligning both connectors and their contact slots, and forming the contiguous hot contact slot and the contiguous neutral contact slot. The tab 19 can be pushed inwards, while holding onto the third female connector 40, to assist in separating the two connectors apart. Optionally the housing may include grips 36. A power adapter cord 330, of FIG. 6b, is required to power cord 33 and any additional cords.

FIG. 2b shows the bottom of the second female connector 30 of FIG. 2a, with no access to the receptacle contact slots from the back (bottom) of the connector, and the tab 19 on the free end.

FIG. 2c shows a perspective view of the third female connector 40 of FIG. 2a, with a slot 29 provided at the back of the receiving port 48, and third grips 36 on the sides of the connector.

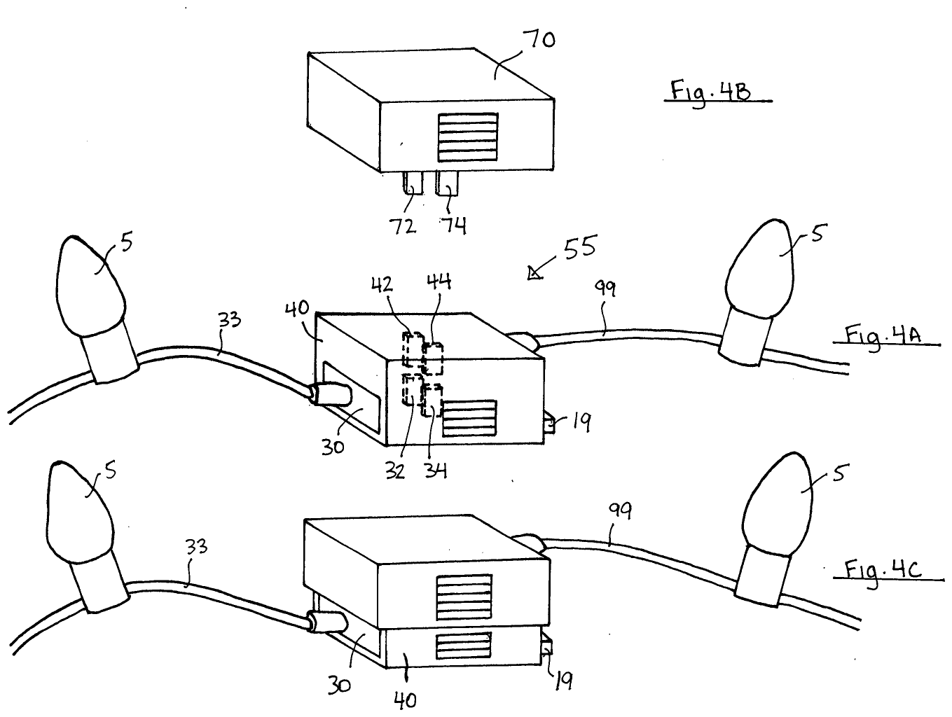

FIG. 2d-2f shows an embodiment of a first linking male fitting 70 with a hot prong (blade) 72 and a neutral prong (blade) 74. The linking male fitting 70, comprises a box shaped housing, with a top and four sides. The hot prong 72 and the neutral prong 74 are secured to the top interior of the male fitting. The hot prong 72 and neutral prong 74 are longer than conventional prongs of a conventional male plug. When a second female connector 30 is inserted and aligned with the third female connector 40 of another cord, as shown in FIG. 4a, the linking male fitting 70 can be inserted into the contact slots of both female connectors, to connectively link them together. A cord slot opening 87 is provided to clear the electrical cord of connector 40.

FIG. 2g shows that a linking male fitting 71 can be attached by a non-electrical cord 76 or the like, connected on the end of the string of Christmas lights 5, for quickly and easily linking and connecting the aligned female connectors 30 and 40, of cord 33 and 99, respectively. If the cord 99 is powered, the linking male fitting 71 and its prongs, will not be live until inserted into connector 40 of electrical cord 99.

An electrical cord or strings of lights can have ends with multiple second or third female connectors or a combination of both. For ease of access, various linking male fittings of the present invention can be secured to one end of the cord.

FIGS. 1 and 2 can be designed with or without polarized connectors, and which can provide additional safety in operating the electrical cords and preventing physical injury.

For the purposes of this application, most references to male fittings, including linking and activating male fittings of the present invention, comprise of an open-box shaped housing with prongs, which when used correctly should prevent any physical contact with the hot and neutral prongs (blades) or any ground prong of a grounded connector, when an electrical connection is being made or disconnected. All male fittings in this application are not wired.

FIG. 3 shows the first female connector 10 of cord 33 of a string of Christmas lights 5, inserted into the receiving port of the first male connector 20 of cord 99 of another string of Christmas lights 5. An electrical connection 45 is formed, when the first female connector enters the receiving port of the first male connector 20, and the contact prongs (blades) of connector 20 enter the contact slots of female connector 10. First grips 16 of connector 10 and second grips 26 of connector 20 are shown. A power adapter 320 (shown in FIG. 6a) is needed to power up the electrical assembly of cords 33 and 99.

FIG. 4a shows Christmas lights 5, with the second female connector 30 of electrical cord 33 fully inserted and aligned in the receiving port of the third female connector 40 of electrical cord 99. The second female connector 30 slides into the third female connector 40 until it stops, aligning both connectors 55 and their electrical contact slots, for use with a linking male fitting 70, of FIG. 4b, to complete the connection and capping the connectors 55, as shown in FIG. 4c. The contiguous slots are formed by the aligned hot contact slot 32 with the hot contact slot 42, and by the aligned third neutral contact slot 34 with the third neutral contact slot 44. A tap 19 on the end of connector 30, is shown exiting the back of connector 40, for separating the two connectors. A power adapter 330 of FIG. 6b, is required to power cords 33 and 99.

FIGS. 4b and 4c shows the first linking male fitting 70 of FIGS. 2d-2f, ready to be inserted into the aligned connectors 55 of FIG. 4a, via the hot prong (blade) 72 entering within the contiguous hot contact slots 42 and 32 and the neutral prong (blade) entering within the contiguous neutral contact slots 44 and 34. The connectors 55 are linked and connected when the first linking male fitting 70 caps the aligned connectors 55, as shown in FIG. 4c. An electrical power connection is formed when either end of connected cords 33 or 99, is connected to either corresponding female connector 30 or 40 of the power adapter 330, and then plugged into an electrical outlet or power source, and described in more detail in FIG. 6b.

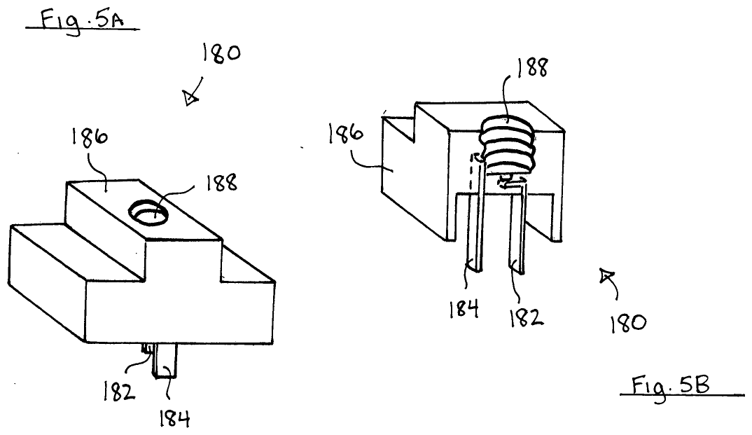

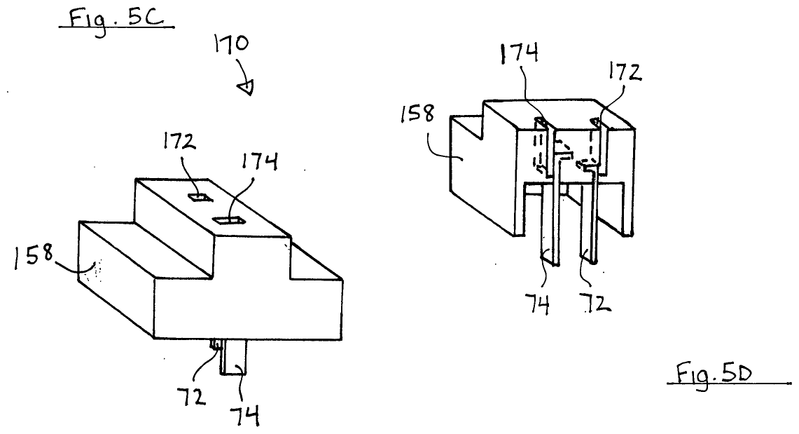

FIG. 5a shows the second linking male fitting 180 comprising a hot prong (blade) 182, a neutral prong (blade) 184, additionally connected to a light socket 188 of the top cap 186 of the male fitting.

FIG. 5b shows a cutout view of the second linking male fitting 180, with the hot prong (blade) 182 and the neutral prong (blade) 184 connected to the bottom and side of light socket 188, respectively, of the top cap 186.

FIG. 5c and cutout view of FIG. 5d, shows a third linking male fitting 170 with a female connector cap 158 having a hot contact slot 172 and a neutral contact slot 174, which join connectively with a hot prong (blade) 72 and a neutral prong (blade) 74, respectively. It will be understood that this adaption of a female connector cap can be applied to all of the activating male fittings.

FIG. 6a shows a first embodiment power adapter cord 320 with a fourth female connector 303 electrically connected to a splitter 327, that splits to a connected first female connector 10 and a connected first male connector 20. The fourth female connector 303 includes a hot contact slot 322 and a neutral contact slot 324, that are continuous and open from the back of the connector 303, as shown in FIG. 6d. The adapter 320 also includes a first activating male fitting 305, having a hot prong (blade) 312 and a neutral prong (blade) 314, for use with connector 303. The prongs (blades) of the activating male fittings form a conventional male plug when inserted into the fourth female connector 303. The power adapter cord 320 powers the string of Christmas lights 5 of FIG. 1a, regardless of which connector 10 or 20, is closest to the power outlet. The first activating male fitting 305, includes a slot opening 318, for grips 319 of connector 303, used to grab and disconnect both connector 303 and activating male fitting 305, when both are engaged or connected at the electrical outlet. The activating male fitting 305, includes and connects to one end of a strap 325, and the other free end of the strap, includes a mount with mounting hole 309, for a screw 308. The first activating male fitting 305, acts as a safety feature by connecting directly to an outdoor cover and/or to a receptacle/power outlet 128. The strap 325, when used correctly, tries to prevent using a power adapter at both ends of the Christmas light assembly, to avoid a hazard of creating a male plug at both ends. A conventional male plug can be used to replace the fourth female connector 303, and the first activating male fitting 305, of the power adapter 320, but may not be as safe in avoiding a male plug at both ends of the assembly, if an adapter were attempted to be used at both ends.

FIG. 6b shows a second embodiment power adapter cord 330, and includes a fourth female connector 303 electrically connected to a splitter 327, that splits to a connected second female connector 30 and a connected third female connector 40, and further includes a first activating male fitting 305, for use with connector 303. The power adapter cord 330 powers the string of Christmas lights 5, of FIGS. 2a and 4c, regardless of which end of the lights, or connector 30 or 40, is closest to the power outlet. Again, the activating male fitting 305 includes a strap 325, connected the fitting, and the other free end of the strap, includes a mount with mounting hole 309, for securing the strap using screw 308.

FIG. 6c-6f shows the first activating male fitting 305 and the fourth female connector 303 of power adapter cords 320 and 330 of FIGS. 6a and 6b, respectively. FIG. 6c shows the front of the fourth female connector 303 and the back of the first activating male fitting 305, with a hot prong (blade) 312 and neutral prong (blade) 314, of power adapters 320 and 330, of FIGS. 6a and 6b, respectively. The fourth female connector 303 includes a hot contact slot 322 and a neutral contact slot 324, with the contact slots being continuous and open from the back of the connector 303 (as shown in FIG. 6d).

FIG. 6d shows a perspective view of the back of the fourth female connector 303, with the hot contact slot 322 and neutral contact slot 324 continuous and open from the back, as well as in the front of the connector, as shown in FIG. 6c.

FIG. 6e shows the front of the first activating male fitting 305 that mounts over the fourth female connector 303, of FIG. 6c, when powering up either adapter 320 or 330, at the power source, showing the hot prong (blade) 312 and the neutral prong (blade) 314.

FIG. 6f shows a side perspective view of the first activating male fitting 305 with a hot prong (blade) 312 and a neutral prong (blade) 314, inserted into the fourth female connector 303, of either adapter cords 320 and 330, of FIGS. 6a and 6b, respectively. Grips 319 allow removal of both connector 303 and activating fitting 305 from a power source when connected and also makes separation from each other easier. Strap 325 of the first activating fitting is also partly shown.

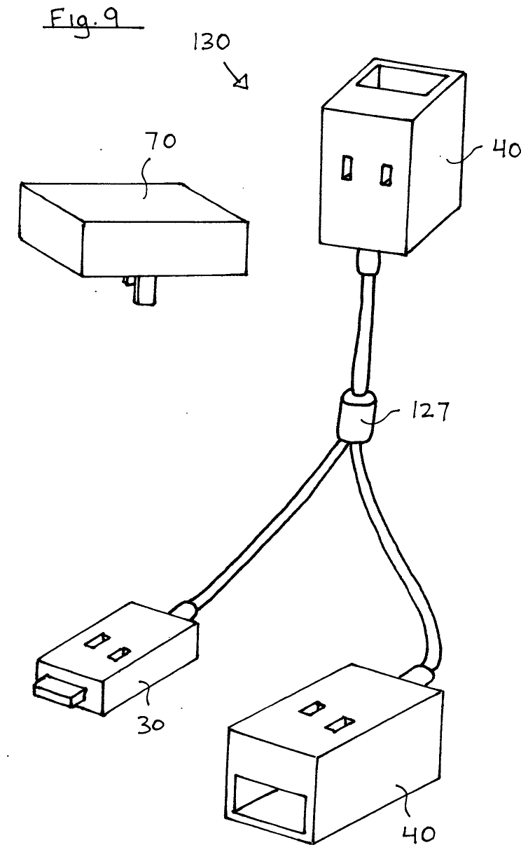

FIG. 7a shows a main power adapter 320 of FIG. 6a, that is used to power Christmas lights 5, of cords 33 and 99, of FIG. 3. The power adapter 320 is plugged into an electrical power receptacle 128, using the first activating male fitting 305 inserted into the fourth female connector 303. The first activating male fitting includes a safety strap 325 that is secured to an outdoor electrical outlet, which can include the receptacle 128 and/or weatherproof cover 301.

FIG. 7b shows an outdoor electrical box with receptacle 128, an outdoor weatherproof cover 301, and the first activating male fitting 305 with strap 325, that can secure to the cover 301 and/or receptacle 128, using mount 309 on the end of the strap 325, using screw 308.

FIG. 8 shows a first embodiment of a splitter adapter cord 120, with a first female connector 10, which is attached by an electrical cord to a splitter 127, that splits to two additional cords, one connected to a further first female connector 10, and the other connected to a first male connector 20. The splitter adapter 120 for use with a string of lights of FIG. 1, allows additional cords to be connected and installed in different directions.

FIG. 9 shows a second embodiment of a splitter adapter cord 130, with a third female connector 40, attached by an electrical cord to a splitter 127, that splits to two additional cords, one connected to a second female connector 30, and the other connected to a further third female connector 40. A linking male fitting 70 is used to connect the splitter adapter to one of the connectors of the electrical cord of FIG. 2a. The splitter adapter 130, allows additional cords to be connected and installed in different directions.

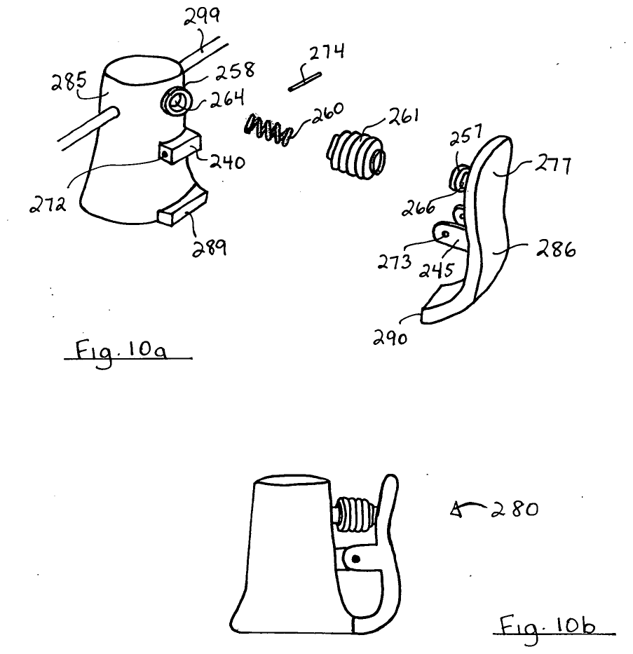

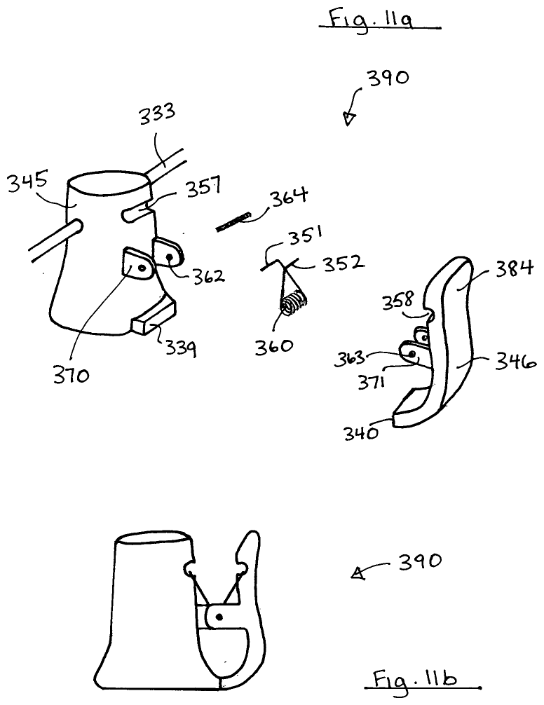

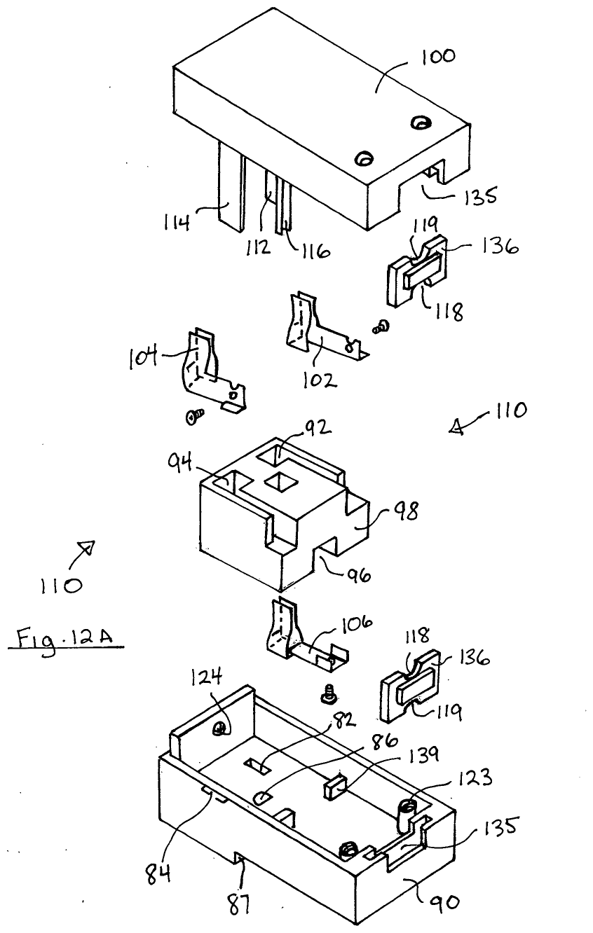

FIGS. 10 and 11 show a light socket clip used for various light strings, including Christmas lights.

FIG. 10a shows an exploded view of the parts of a light socket clip 280, including the light socket 285, the elongate body member 286, a compression spring 260, a retaining pin 274, and a boot cover. The light socket 285, connected to electrical cord 299, includes an exterior housing with mount 240, having a pivot mounting hole 272. The elongated body member 286, includes mounting members 245, each having a pivot mounting hole 273, for aligning and securing to the mount 240, using the retaining pin 274. The exterior of the light socket 285 further includes a spring retaining housing 264, near the top of the housing, and directly above the mount 240, for retaining and securing one end of a compression spring 260. The elongated body member 286 includes a spring retaining housing 266, for retaining and securing the other end of the compression spring 260. Both spring retaining housings 264 and 266 of the light socket 285, and the elongate member 286, respectively, can include an outer lip 258 and 257, respectively, for securing the ends of a rubber boot 261, used to cover and protect the compression spring 260. The light socket 285 includes a jaw 289, directly below the housing mount 240, and the elongate member 286 includes a jaw 290 directly below the mounting members 245, for gripping or securing to an object. A grip 277 on the exterior of the elongate member 286, operates the clip by gripping the elongate member and the exterior housing of the light socket.

FIG. 10b shows a perspective view of the assembled light socket clip 280.

FIG. 11a shows an exploded view of the parts of a light socket clip 390, including a light socket 345 connected to electrical cord 333, an elongated body member 346, a torsion spring 360 and a retaining pin 364. The light socket 345 includes an exterior housing with mounting members 370, each having a pivot mounting hole 362. The elongated body member 346 includes mounting members 371, each with pivot mounting holes 363, aligning with the pivot mounting holes 362, for connecting to the light socket 345, using a retaining pin 364. The light socket further includes a slot groove 357 near the top and directly above the two mounting members 370, for securing one of the arms of the torsion spring 360, and a jaw or gripping portion 339 directly below the two mounting members 370, located at the base of the light socket 345. The elongated member 346 includes a slot groove 358 near the top and directly above the two mounting members 371, for securing the other arm of the torsion spring, and also includes a jaw or gripping portion 340, directly below the two mounting members 371. A grip 384 on the top exterior of the elongate member 346, operates the clip by gripping the elongate member and the exterior housing of the light socket.

FIG. 11b shows a perspective view of the assembled light socket clip 390.

It will be understood, that both light socket clips of FIGS. 10 and 11, can be used for other lighting applications, not just Christmas lights. The light socket housing and the elongated body member can have various physical shaping, ie straight and flat, or include a rounded design, or a combination of both, to provide the proper clipping action required, for various applications.

References to “housing” refer to the appropriate molded and accessible housing combination that may be used in the invention depending on the need to access the electrical receptacle.

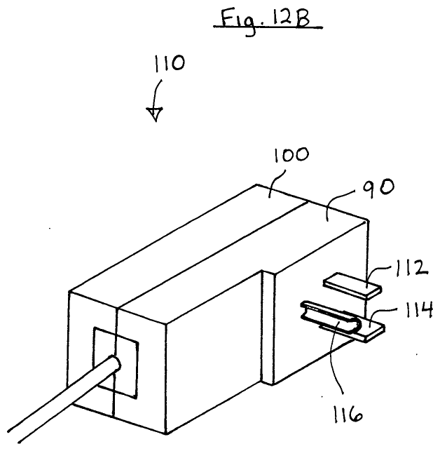

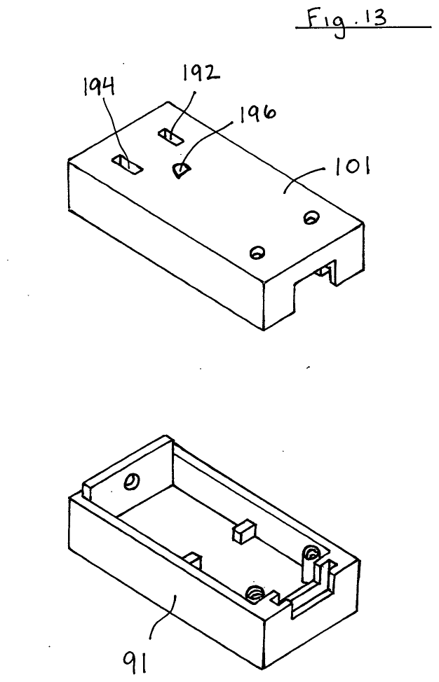

FIGS. 12 and 13 refer to an adaptable replacement connector having internal parts that are common to both a male and female replacement connector. FIG. 12 refers to a male replacement connector, and FIG. 13 refers to a female replacement connector.

FIG. 12a shows a first adaptable male replacement connector 110 with a replaceable cover 100, a first mounting base 90, an inner housing 98, and electrical contacts with wire terminals, including a hot contact with terminal 102, a neutral contact with terminal 104 and a ground contact with terminal 106, all housed in the corresponding slots 92, 94 and 96, of the inner housing, respectively. A mounting base 90 includes body members 139, for providing a slot to position and secure the inner housing and the electrical contacts. The mounting base 90 includes slot openings 82, 84 and 86, for a hot prong (blade) 112, a neutral prong (blade) 114, and a ground prong 116, of the male replacement cover 100, respectively. The mounting base 90 also provides threaded cylinders 123 and a threaded bore 124 for the male replacement cover 100 to secure to, using the mounting holes 133 on the top and mounting hole 134 on the end, respectively, with screws 126 and 128, respectively. The outside surface of the mounting base 90 includes a extending member 87 for the hot prong (blade) 112, neutral prong (blade) 114 and ground prong 116 of the male replacement cover to provide them with extra support. Both the mounting base 90 and the replacement cover 100, include a slot 135 for the cord inserts 136. The cord inserts 136 are reversible, and include a top rounded edge 118 and a bottom rounded edge 119, for use with either a big gauge electrical cord or a smaller gauge electrical cord, respectively. The cord slots 135, and cord inserts 136, provide the entry for the electrical cord to be wired to the male replacement connector 110. The electrical contacts 102, 104 and 106, and inner housing slots 92, 94 and 96, are continuous and open from the back, allowing the hot prong (blade) 112, the neutral prong (blade) 114 and ground prong 116 to enter the contact slots with electrical contacts, and then exit the mounting base 90. The connector provides easy replacement of the cover if any of the prongs become damaged without requiring any rewiring.

The slot openings of the mounting base 90 can be provided with guides or bevels, to guide the ends of prongs out the contact slot openings, and can provide a tight fit of the blades or prongs, similar to conventional plugs.

FIG. 12b shows the male replacement connector 110, with the mounting cover 100 mounted and secured to mounting base 90 and connected to an electrical cord, and with hot prong 112, neutral prong 114 and ground prong 116 exiting the mounting base. Cord inserts 136 are shown at the cord end of the connector.

An adaptable female replacement connector uses the same internal housing of the adaptable male replacement connector of FIG. 12a, which includes the internal housing and the electrical contacts with wire terminals.

FIG. 13 shows a female replacement cover 101 and a mounting base 91 of an adaptable female replacement connector. The cover 101, having contact slot openings 192, 194 and 196, that correspond with the hot contact 102, the neutral contact 104 and the ground contact 106, of an inner housing 98, shown in FIG. 12a. The mounting base 91 has no slot openings as compared to the male mounting base of FIG. 12a.

Both adaptable replacement connectors of FIGS. 12 and 13 can additionally be colored coded for ease of recognizing a connector meant for either a male replacement connector or a female replacement connector. Also, both adaptable replacement connectors of FIGS. 12 and 13 can be applied for various applications or connectors, including a connector with or without a ground prong, a connector with more than two prongs, or a connector for more than one hot contact.

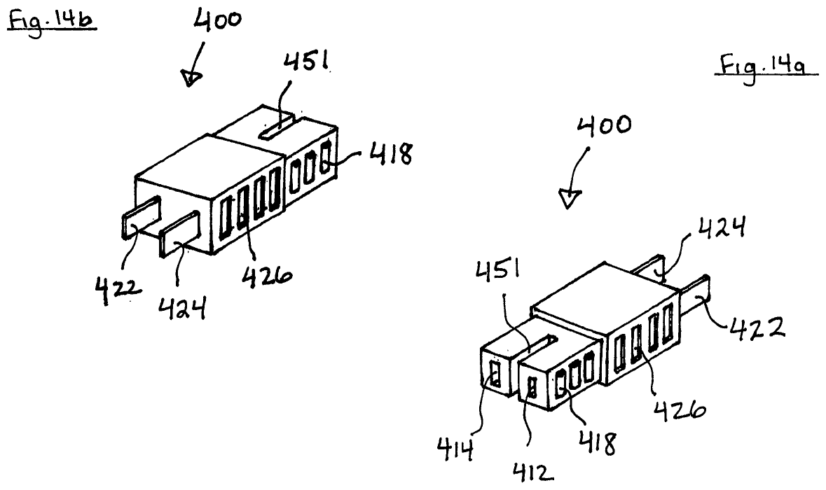

FIGS. 14a and 14b shows a first embodiment connector adapter 400 comprising a female connector end and a male connector end of the first female connector 10 and first male connector 20 of figure la respectively, connected and linked together.

FIG. 14a shows a perspective view of the back of the adapter 400 with a female connector end comprising a hot contact slot 412 and a neutral contact slot 414, connected to the hot prong 422 and the neutral prong 424, respectively, of the male connector end, shown in a front view in figure in FIG. 14b. The female connector end includes slot 451 in the housing between the hot and neutral slots. Slot 451 corresponds to partition tab 53 of the first male connector 20 of FIG. 1a. The adapter also includes grips 418 on the sides of the female end, for gripping the insides of the receiving port of the first male connector 20 when connected together. The male connector end includes grips 426 for gripping the adapter when disconnecting it from a first female connector 10 or when unplugging it from an electrical outlet or electrical cord.

It will be understood that the figures show no contact slot for a ground in some examples and a contact slot for a ground in other examples, and it will be understood that either can be used depending on the needs. As well, just as with conventional cords, the connectors of the present invention can be for interior or exterior use. It will also be understood that the prongs and contact slots can be adapted depending on the country's electrical conventions/needs, and the examples show North American standards just for illustration purposes, but the invention is not limited to the same.

The receptacle of the various female connectors can include contact slots of various design, spacing, size and depth, and can be staggered, for use and matching to the design, spacing, size and length of the blades/prongs of its corresponding male connector or fitting.

The Christmas light string connectors and various adapter cord connectors can be of different sizes, including sizes able to accept and connect with conventional connectors, and designed with safety in mind. The electrical cords can vary in length, and have various components. The wiring, connector ends, fittings and adapters can be designed for a two or more prong circuit, with or without a ground wire, and designed for use in multiple countries and for the specific voltage used in those countries.

The connectors of the present invention can be used for both interior or exterior electrical cords, including light strings that have various numbers of incandescent bulbs or light-emitting diodes (LEDs), or cords with ornamental lights.

A sleeve cover can be installed over any connector not in use to protect for added protection.

While embodiments of the invention have been described in the detailed description, the scope of the claims should not be limited by the preferred embodiments set forth in the examples, but should be given the broadest interpretation consistent with the description as a whole.

The applicants, inventors or owners, reserve all rights that they may have in any invention disclosed in an apparatus or process described above that is not claimed in this document. For example, the right to claim such invention in a continuing application and do not intend to abandon, disclaim or dedicate to the public any such invention by its disclosure in this document.

What is claimed is:

1. An electrical assembly comprising:
a cord set comprising:
a first electrical cord,
a first female connector electrically connected to one end of the first electrical cord; and
a second female connector electrically connected to the other end opposite the one end of the first electrical cord;
wherein the first female connector includes a housing enclosing an electrical receptacle, the housing including a hot slot and a neutral slot, the electrical receptacle including a hot contact with terminal and a neutral contact with terminal, the hot contact with terminal disposed in the hot slot, the neutral contact with terminal disposed in the neutral slot, the hot and neutral terminals extending from one side of each hot and neutral contact surfaces, the hot terminal and neutral terminal electrically connected to the corresponding wires at the end of the first electrical cord;
wherein the second female connector includes a housing enclosing an electrical receptacle and a open receiving port below the electrical receptacle, the housing including a hot slot and a neutral slot, the electrical receptacle including a hot contact with terminal and a neutral contact with terminal, the hot contact disposed in the hot slot, the neutral contact disposed in the neutral slot, the hot terminal and neutral terminal electrically connected to the corresponding wires on the other end opposite the one end of the first electrical cord;
wherein the hot slot and the neutral slot are additionally open to the receiving port below;
wherein the receiving port is open at one end and sized to receive a first female connector of another electrical cord within it;
a first linking male fitting comprising:
a top, two sides, two end surfaces, a hot prong, a neutral prong, and a plurality of cord slots, the hot prong and the neutral prong attached and embedded in the top surface and pointing to the opposite open end,
the plurality of cord slots include an electrical cord slot in each end surface, each cord slot for sliding over the electrical cords connected to each of the aligned connectors;
wherein the first linking male fitting for inserting into the hot and neutral contact slots of the second female connector and into the aligned contact slots of a first female connector of another electrical cord inserted into the receiving port of the second female connector, the linking male fitting electrically linking both first and second female connectors together and forming the continuous hot and neutral contact slots; and
wherein the linking male fitting encloses most or all of the access of the open end of the receiving port of the second female connector to protect from accidental or physical contact with the prongs.

2. An electrical assembly of claim 1, further comprising:
an adaptor;
the adapter comprising:
a second electrical cord,
a first female connector electrically connected to one end of the second electrical cord, and
a male plug electrically connected to the other end opposite the one end of the second electrical cord;
wherein the first female connector includes a housing enclosing an electrical receptacle, the housing including a hot slot and a neutral slot, the electrical receptacle including a hot contact with terminal and a neutral contact with terminal, the hot contact disposed in the hot slot, the neutral contact disposed in the neutral slot, the hot terminal and the neutral terminal electrically connected to the corresponding wires at one end of the second electrical cord;
wherein the male plug includes a housing for a hot prong with terminal and a neutral prong with terminal, the hot terminal and the neutral terminal enclosed in the housing and electrically connected to the corresponding wires on the other end opposite the one end of the second electrical cord;
wherein the electrical assembly receives power when the first female connector of the adapter and the second female connector of the cord set is electrically connected by using the linking male fitting, and the male plug is plugged into an electrical receptacle or electrical outlet.

3. An electrical assembly of claim of claim 1, further comprising:
an adaptor,
the adapter comprising:
a second electrical cord,
a first female connector electrically connected to one end of the second electrical cord;
a third electrical cord,
a second female connector electrically connected to one end of a third electrical cord, the other end opposite the one end of the third electrical cord is electrically connected to a first location on the second electrical cord;
wherein the first female connector includes a housing enclosing an electrical receptacle, the housing including a hot slot and a neutral slot, the electrical receptacle including a hot contact with terminal and a neutral contact with terminal, the hot contact disposed in the hot slot, the neutral contact disposed in the neutral slot, the hot terminal and the neutral terminal electrically connected to the corresponding wires at one end of the second electrical cord;
wherein the second female connector includes a housing enclosing an electrical receptacle and a open receiving port below the electrical receptacle, the electrical receptacle including a hot contact with terminal and a neutral contact terminal, the hot contact disposed in the hot slot, the neutral contact disposed in the neutral slot, the hot terminal and the neutral terminal electrically connected to the corresponding wires at one end of the second electrical cord;
wherein the hot slot and the neutral slot are additionally open to the receiving port below, the receiving port is open at one end and sized to receive a first female connector of a cord set within it;
a first splitter;
the first splitter housing encloses the electrical connection between the other end of the third electrical cord and the first location on the second electrical cord; and
a male plug;
the male plug is electrically connected to the other end opposite the one end of the second electrical cord;
wherein the male plug includes a hot prong and a neutral prong, the hot prong and the neutral prong are electrically connected to the corresponding wires at the other end opposite the one end of the second electrical cord;
wherein the electrical assembly receives power when either the first or second female connector of the adapter is electrically connected with a linking male fitting to a either corresponding connector of the cord set and the male plug is plugged into an electrical outlet.

4. An adaptable electrical connector comprising:
a mounting base, an internal housing, electrical contacts with terminals, a detachable cover with contact prongs, and mounting screws;
the male mounting base comprising:
a bottom, two sides and two end surfaces, contact slot openings, an internal slot, an inner flange, screw retaining members, and a cord slot opening;
the contact slot openings in the bottom surface, the contact slot openings including a hot slot opening and a neutral slot opening, the hot and neutral slot openings for receiving a corresponding hot and neutral prong of the detachable cover;
an internal slot including two perpendicular members, each perpendicular member attached the bottom surface and one side surface, the internal slot for retaining the internal housing in position, the internal housing for housing the electrical contacts with wire terminals;
the inner flange at the top edge at both sides of the mounting base and at one end for positioning and providing structural support of both the mounting base and the detachable cover, the inner flange at the one end including a bore opening for a mounting screw;
the screw retaining members disposed in the interior of the mounting base extending perpendicular from the bottom edge surface near the cord end, the screw retaining members for receiving the mounting screws for securing the mounting cover to the mounting base;
a cord slot opening in the end surface opposing the inner flange for receiving an electrical cord for wiring to the connector;
the internal housing comprising:
a plurality of slot openings for receiving and retaining the corresponding electrical contacts with wire terminals, the slot openings including a hot slot and a neutral slot;
the electrical contacts with wire terminals include a hot contact and a neutral contact, the hot contact and the neutral contact each including one or more sides, a top and bottom edge surface, and a wire terminal extending from one side for electrically connecting to a corresponding hot and neutral wire of an electrical cord, one side of the side surfaces of each hot and neutral contact includes an inline curve along the surface for contact with the corresponding hot and neutral prong of the detachable cover, each electrical contact adjacently aligning with the corresponding hot and neutral slot openings of the mounting base;
the detachable cover comprising:
a top, two sides, two ends, a hot prong, a neutral prong, and a cord slot in the end surface;
the hot and neutral prong embedded and attached at the top and pointing to the open end, the prongs for inserting into the electrical contact slots of the internal housing and making contact with the electrical contacts and exiting out the contact slot openings of the mounting base;
the cord slot for an electrical cord to be inserted and the wires electrically connected to the terminals; and
the mounting holes in the top surface and a mounting hole at the opposing end of the cover for aligning with the corresponding screw retainers and mounting hole of the mounting base;
the mounting screws for securing the assembly together and forming a male connector, and
wherein the detachable cover alone can be easily replaced when any part of the cover or prongs become damaged.

5. An adaptable electrical connector of claim 4, further comprising:
a ground,
the ground comprising:
a ground slot openings, an electrical ground contact with wire terminal and a ground prong with terminal;
wherein the mounting base further comprises a ground slot opening for a ground prong of the detachable cover;
wherein the internal housing further comprises a ground slot opening for receiving and retaining an electrical ground contact with wire terminal;
wherein the electrical contacts with wire terminals further includes an electrical ground with wire terminals, the ground contact including one or more sides, top and bottom edge surfaces, and a wire terminal extending from one side for electrically connecting to a grounding wire of an electrical cord, one side of the side surface of the ground contact includes an inline curve along the surface for contact with the ground prong, the ground contact adjacently aligning with the corresponding ground slot opening in the mounting base;
wherein the detachable cover further includes a ground prong, the ground prong embedded and attached at the top and pointing to the open end, the ground prong for inserting into the electrical ground slot of the internal housing and making contact with the ground contact and exiting out the ground slot opening of the mounting base.

6. An electrical assembly comprising:
an electrical cord set comprising:
a first electrical cord,
a first female connector electrically connected to one end of the first electrical cord;
a first activating female connector electrically connected to the other end opposite the one end of the first electrical cord; and
a first removable activating male fitting;
wherein the first female connector includes a housing enclosing an electrical receptacle, the housing including a hot slot and a neutral slot, the electrical receptacle including a hot contact with terminal and a neutral contact with terminal, the hot contact disposed in the hot slot, the neutral contact disposed in the neutral slot, the hot terminal and the neutral terminal extending from one side of the hot and the neutral contact surfaces, each terminal electrically connected to the corresponding wires at the end of the first electrical cord;
wherein the first activating female connector includes a housing enclosing an electrical receptacle shaped to receive a removable activating male fitting, the electrical housing including a continuous hot slot that extends there through and a continuous neutral slot that extends there through, the electrical receptacle including a hot contact with terminal and a neutral contact with terminal, the hot contact disposed adjacently within the continuous hot slot and the neutral contact disposed adjacently within the continuous neutral slot, the hot and neutral contacts each including one or more sides, top and bottom edge surfaces, side of the side surfaces of each hot and neutral contacts having an inline curve for contact with the hot and neutral prong of the removable male fitting; the hot terminal and neutral terminal extending from one side for electrically connecting to the corresponding wires at the other end opposite the one end of the first electrical cord, the hot and neutral contacts having an open continuous passageway from the top edge surface to bottom edge surface for receiving the hot prong and the neutral prong of the removable activating male fitting, forming the continuous hot and neutral contact slots;
wherein the first removable activating male fitting includes two sides, two ends, a top opposing an open end, a hot prong, a neutral prong, and at least one slot disposed in one of the end surfaces;
the hot prong and the neutral prong embedded and attached to the top and pointing to the opposite open end;
wherein the removable activating male fitting inserts into the activating female connector and the slot disposed on the end surface slides over the first electrical cord connected to the activating female connector to form a male plug, the male plug for plugging the electrical assembly into an electrical receptacle or electrical outlet, and wherein the activating male fitting can be easily replaced if damaged.

7. The electrical assembly of claim 6, wherein the activating male fitting further includes a mounting strap;
the mounting strap having two ends, one end of the mounting strap is attached to the activating male fitting, and the other end opposite the one end is attached to the first electrical cord near the activating female connector for securement and ease of accessability.
